(19) United States
(12) Patent Application Publication
(10) Pub. No.: US 2018/0230810 A1
(43) Pub. Date: Aug. 16, 2018

(54) INTERLOCKING MODULAR AIRFOIL FOR A GAS TURBINE

(71) Applicant: Siemens Aktiengesellschaft, München (DE)

(72) Inventors: Zachary D. Dyer, Chuluota, FL (US); Phillip W. Gravett, Orlando, FL (US); Allister William James, Chuluota, FL (US); Sachin R. Shinde, Oviedo, FL (US)

(21) Appl. No.: 15/750,518

(22) PCT Filed: Aug. 28, 2015
(86) PCT No.: PCT/US2015/047312

§ 371 Date: Feb. 6, 2018

(51) Int. Cl. F01D 5/14; F01D 5/18; F01D 9/04; F01D 25/00; F01D 25/12

(52) U.S. Cl. CPC F01D 5/147; F01D 5/187; F01D 9/041; F01D 25/005; F01D 25/12; F05D 2230/51; F05D 2230/64; F05D 2260/201; F05D 2300/6033; F05D 2300/174; F05D 2220/32

(57) ABSTRACT

An interlocking modular airfoil for a turbine. The airfoil includes at least one support column extending from a lower plate and at least one first filament having at least one first side aperture that receives the support column in a first transverse direction. The airfoil also includes at least one second filament having at least one second side aperture that receives the support column in a second transverse direction, wherein the second filament includes a flange for covering the first side aperture. In addition, the airfoil includes a cooling channel extending through the support column, wherein the support column includes apertures for emitting a cooling fluid transmitted via the cooling channel for cooling the first and second filaments. Further, the airfoil includes an upper plate located on top of the first and second filaments for maintaining the first and second filaments under compression.

### FIELD OF THE INVENTION

This invention relates to airfoils, such as vanes or blades, used in a gas turbine, and more particularly, to an airfoil having at least one first filament that includes at least one first side aperture that receives a support column in a first transverse direction. The airfoil also includes at least one second filament having at least one second side aperture that receives the support column in a second transverse direction. The second filament also includes a flange for covering the first side aperture. Further, the airfoil includes an upper plate for maintaining the first and second filaments under compression.

### BACKGROUND OF THE INVENTION

In various multistage turbomachines used for energy conversion, such as gas turbines, a fluid is used to produce rotational motion. Referring to FIG. 1, an axial flow gas turbine 10 includes a multi-stage compressor section 12, a combustion section 14, a multi stage turbine section 16 and an exhaust system 18 arranged along a center axis 20. Air at atmospheric pressure is drawn into the compressor section 12 generally in the direction of the flow arrows F along the axial length of the turbine 10. The intake air is progressively compressed in the compressor section 12 by rows of rotating compressor blades, thereby increasing pressure, and directed by mating compressor vanes to the combustion section 14, where it is mixed with fuel, such as natural gas, and ignited to create a combustion gas. The combustion gas, which is under greater pressure, temperature and velocity than the original intake air, is directed to the turbine section 16. The turbine section 16 includes a plurality of airfoil shaped turbine blades 22 arranged in a plurality of rows R₁, R₂, etc. on a shaft 24 that rotates about the axis 20. The combustion gas expands through the turbine section 16 where it is directed in a combustion flow direction F across the rows of blades 22 by associated rows of stationary vanes 24. A row of blades 22 and associated row of vanes 24 form a stage. In particular, the turbine section 16 may include four stages. As the combustion gas passes through the turbine section 16, the combustion gas causes the blades 22 and thus the shaft 24 to rotate about the axis 20, thereby extracting energy from the flow to produce mechanical work.

A method for increasing the efficiency of a turbine is to increase an operating temperature of the turbine. Operating a turbine at higher temperatures frequently requires the use of specialized high heat resistant materials that are difficult to manufacture into turbine components such as vanes and/or blades. It is desirable to enhance the manufacturability of turbine vanes and/or blades that utilize high heat resistant materials.

### SUMMARY OF INVENTION

An interlocking modular airfoil for a turbine is disclosed. The airfoil includes at least one support column extending from a lower plate and at least one first filament having at least one first side aperture that receives the support column in a first transverse direction. The airfoil also includes at least one second filament having at least one second side aperture that receives the support column in a second transverse direction, wherein the second filament includes a flange for covering the first side aperture. In addition, the airfoil includes a cooling channel extending through the support column, wherein the support column includes apertures for emitting a cooling fluid transmitted via the cooling channel for cooling the first and second filaments. Further, the airfoil includes an upper plate located on top of the first and second filaments for maintaining the first and second filaments under compression.

In addition, the invention includes a method for assembling an airfoil for a turbine. The method includes providing at least one support column extending from a lower plate and at least one first filament having at least one first side aperture that receives the support column in a first transverse direction. The method also includes providing at least one second filament having at least one second side aperture that receives the support column in a second transverse direction opposite the first direction, wherein the second filament includes a flange for covering the first side aperture. In addition, the method includes heating the support column to lengthen the support column and attaching an upper plate to the support column. Further, the method includes cooling the support column to contract the support column and place the first and second elements under compression.

Those skilled in the art may apply the respective features of the present invention jointly or severally in any combination or sub-combination.

### BRIEF DESCRIPTION OF DRAWINGS

The teachings of the present disclosure can be readily understood by considering the following detailed description in conjunction with the accompanying drawings, in which:

FIG. 1 is a partial cross sectional view of an axial flow gas turbine.

FIG. 2 is a view of a modular turbine vane in accordance with an embodiment of the invention.

FIG. 3 is a view of a lower backing plate of the vane without filaments installed.

FIG. 4 is view of an upper backing plate of the vane along view line 4-4 of FIG. 2.

FIGS. 5-6 show top and bottom views, respectively, of an exemplary vane base filament.

FIGS. 7-8 show top and bottom views, respectively, of a first vane filament.

FIG. 9 is a perspective view of the first filament along view line 9-9 of FIG. 7.

FIG. 10 is a view of the first filament along view line 10-10 of FIG. 5.

FIGS. 11-13 depict a filament assembly sequence for forming the vane.

FIG. 14 is a view of a modular turbine blade in accordance with an alternate embodiment of the invention.

FIG. 15 is a view of a blade hub of the blade without filaments installed.

FIG. 16 depicts downward and upward flanges of a flanged filament.

FIG. 17 depicts a plurality of filaments installed on support beams.

FIG. 18 is a partial cross sectional view of an end filament along view line 18-18 of FIG. 17.

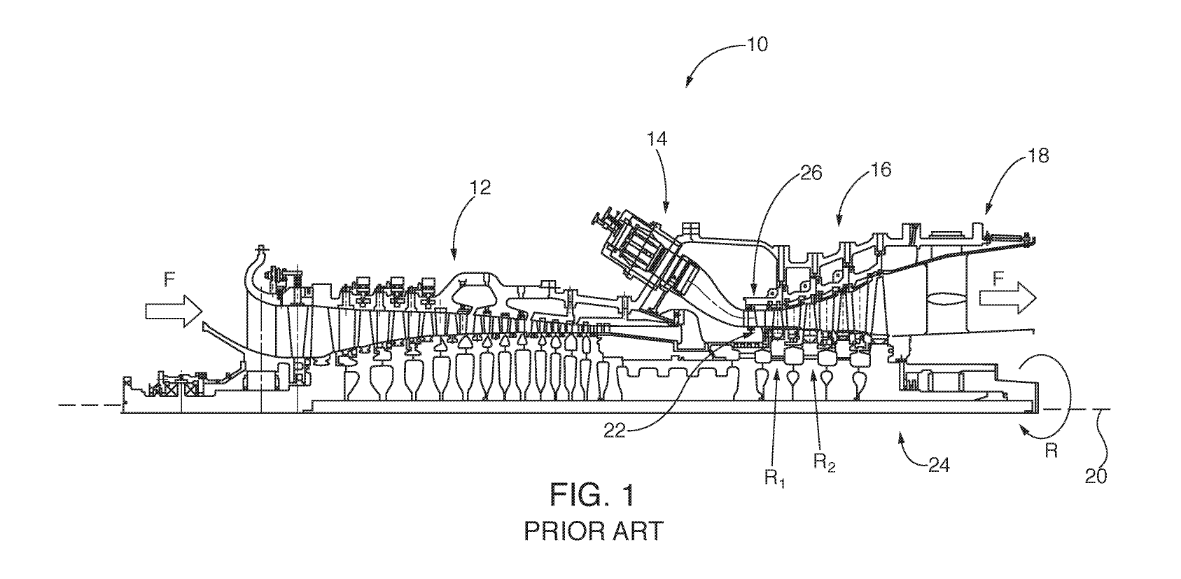

To facilitate understanding, identical reference numerals have been used, where possible, to designate identical elements that are common to the figures.

### DETAILED DESCRIPTION

Although various embodiments that incorporate the teachings of the present disclosure have been shown and described in detail herein, those skilled in the art can readily devise many other varied embodiments that still incorporate these teachings. The scope of the disclosure is not limited in its application to the exemplary embodiment details of construction and the arrangement of components set forth in the description or illustrated in the drawings. The disclosure encompasses other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass direct and indirect mountings, connections, supports, and couplings. Further, “connected” and “coupled” are not restricted to physical or mechanical connections or couplings.

The current invention enables fabrication of an airfoil used in a gas turbine 10, such as either a vane or blade of a turbine section 16, having enhanced heat resistance while also providing sufficient structural integrity. In particular, the current invention enables fabrication of a vane or blade that is suitable for use in hot areas of the turbine such as row 1 of a turbine. The current invention may also be used in fabricating relatively large blades to reduce the weight of a large blade and thus mechanical stresses.

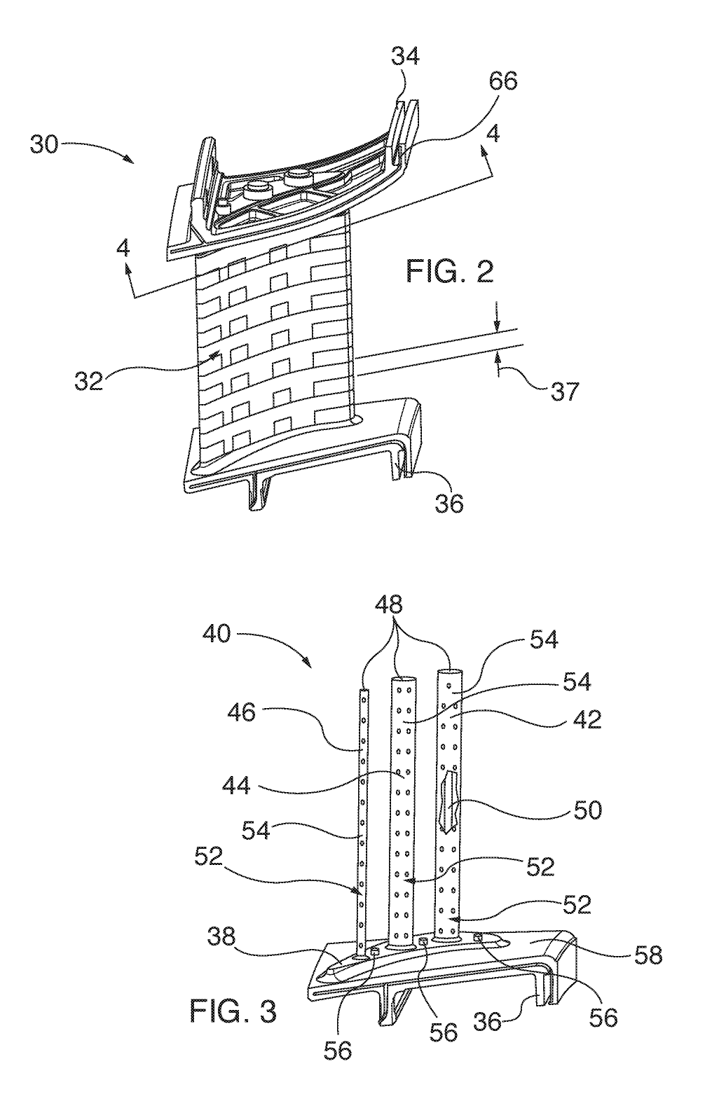

Referring to FIG. 2, a modular vane 30 in accordance with an embodiment of the invention is shown. The vane 30 includes a plurality of vane filaments 32 arranged in a stacked configuration between upper 34 and lower 36 vane backing plates. The filaments 32 are each fabricated from a high heat resistant material suitable for use in a turbine vane or blade. For example, the material may be a ceramic matrix composite (CMC) material or a Titanium Aluminide (TiAl) material. Alternatively, at least one filament 32 may be fabricated from one type of high heat resistant material whereas the remaining filaments 32 may be fabricated from another type of high heat resistant material. The filaments 32 are each shaped such that a suitable vane airfoil shape is formed when the filaments 32 are stacked or assembled. The filaments 32 may each have a first thickness 37. In an embodiment, the thickness 37 of a filament 32 fabricated from CMC material may be approximately 10-12 mm thick. Alternatively, at least one filament 32 may have a thickness that is greater or less than the first thickness 37.

Referring to FIG. 3, the lower backing plate 36 is shown without the filaments 32 installed. The lower backing plate 36 includes a lower platform 38 having a plurality of support beams 40 that extend from the lower platform 38 in a radial direction relative to the center axis 20. In an embodiment, the lower backing plate 36 includes first 42, second 44 and third 46 support beams each having a threaded end 48. Each support beam 42, 44, 46 includes an internal channel 50 (shown as a cutaway view in third support beam 46) and a plurality of apertures 52 that extend through an outer surface 54 of each support beam 42, 44, 46 such that each internal channel 50 and associated apertures 52 are in fluid communication. In use, each internal channel 50 receives cooling air or fluid that is then emitted from the apertures 52 and impinges on the filaments 32 in order to cool the filaments 32. A plurality of alignment pins 56 also extend from platform 38. The support beams 42, 44, 46 and pins 56 serve to support and align the filaments 32 as will be described. The lower backing plate 36, support beams 42, 44, 46 and pins 56 may be integrally or unistructurally formed, such as by a casting process, to form a one-piece configuration. In an embodiment, lower backing plate 36, support beams 42, 44, 46 and pins 56 may be formed from a known Conventional Cast (CC) alloy or Directionally Solidified (DS) alloy. The lower platform 38 extends through a lower shroud element 58 that covers portions of the lower backing plate 36. The lower shroud 58 is fabricated from a heat resistant material that serves to reduce exposure of the lower backing plate 36 to high temperatures. In an embodiment, the lower shroud 58 is fabricated from CMC material or a known thermal barrier coating.

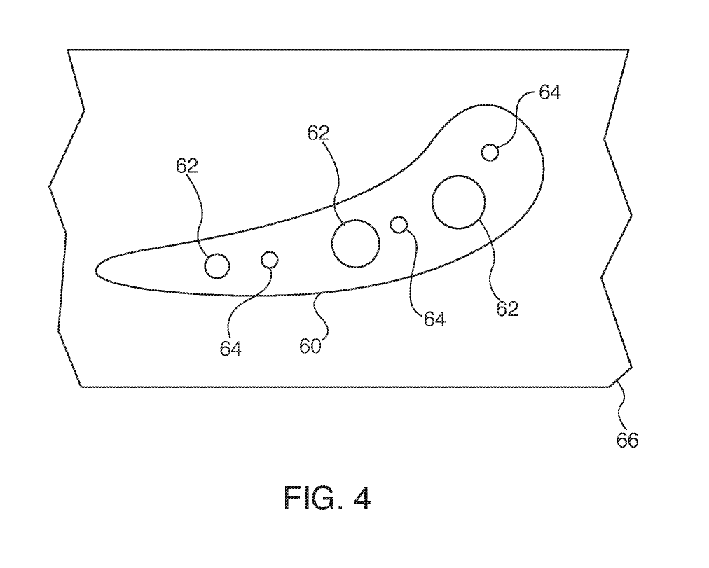

Referring to FIG. 4, a view of the upper backing plate 34 along view line 4-4 of FIG. 2 is shown. Referring to FIG. 4 in conjunction with FIG. 2, the upper backing plate 34 includes an upper platform 60 having holes 62 for receiving the support beams 42, 44, 46. The upper platform 60 also includes alignment holes 64 configured to receive alignment pins of an underlying filament as will be described. An upper shroud element 66 covers portions of the upper backing plate 34. The upper shroud 66 is fabricated from a heat resistant material that serves to reduce exposure of the upper backing plate 34 to high temperatures such as CMC material or a known thermal barrier coating.

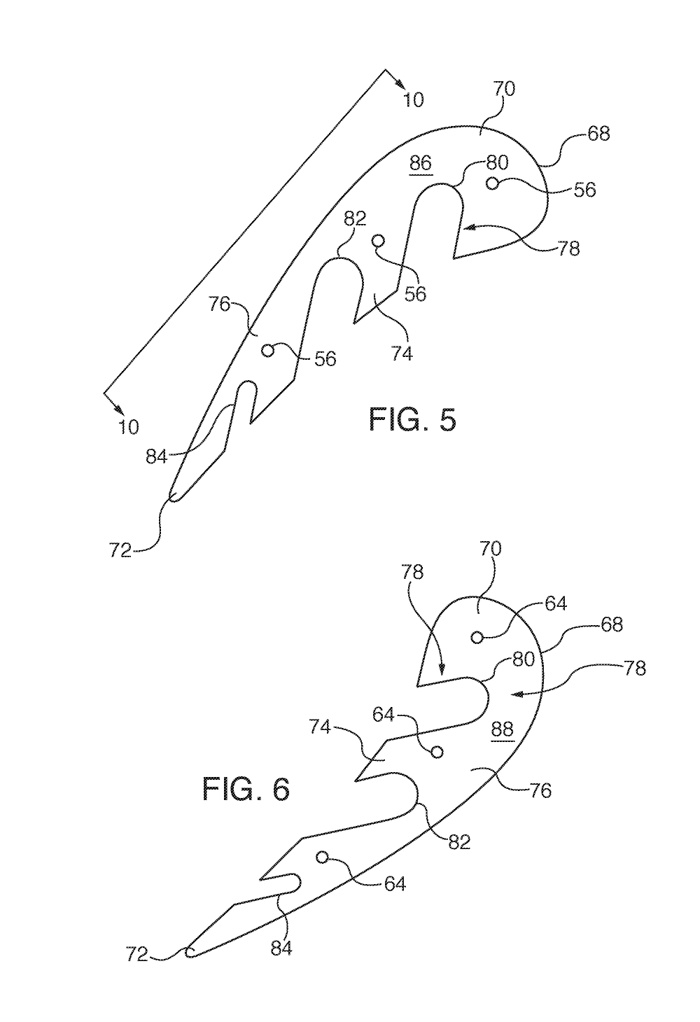

FIGS. 5-6 show top and bottom views, respectively, of an exemplary vane base filament 68. The base filament 68 includes leading 70 and trailing 72 edges and a concave profile high-pressure side surface 74 and a convex profile low-pressure side surface 76. The base filament 68 also includes a plurality of side apertures 78 that extend into the base filament 68 from the concave side surface 74 of the base filament 68. In an embodiment, the base filament 68 includes first 80, second 82 and third 84 side apertures for receiving the first 42, second 44 and third 46 support beams, respectively. The base filament 68 also includes a top surface 86 having alignment pins 56 (see FIG. 5) and a bottom surface 88 having alignment holes 64 (see FIG. 6). Alternatively, the pins 56 and alignment holes 64 may be formed on bottom 88 and top 86 surfaces, respectively, of the base filament 68.

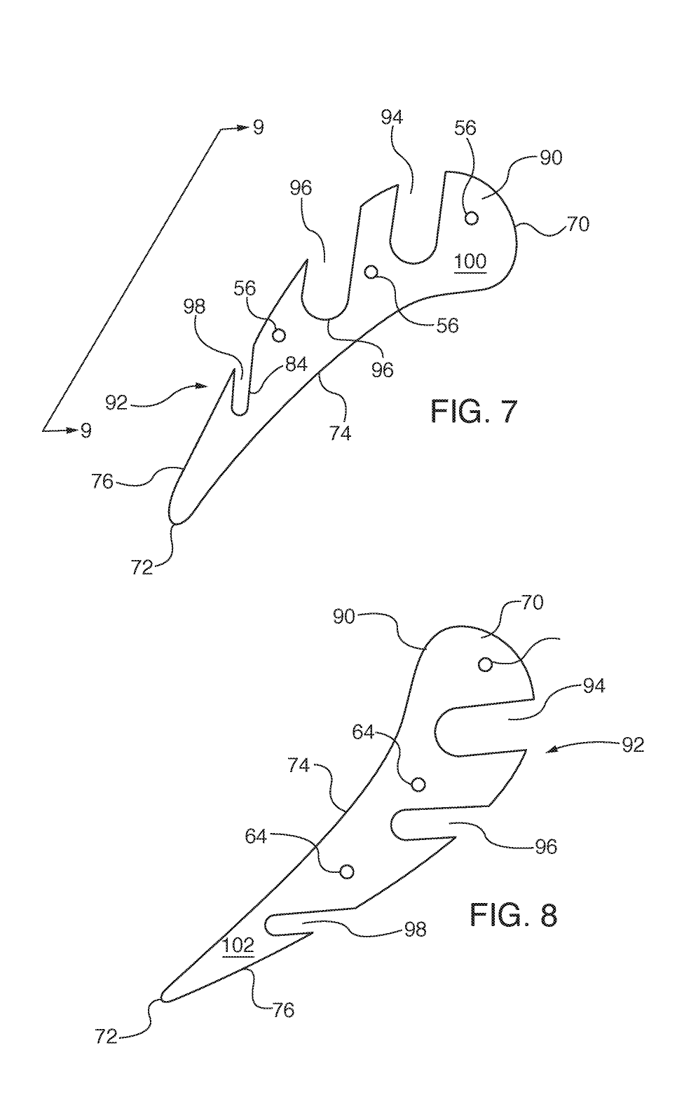

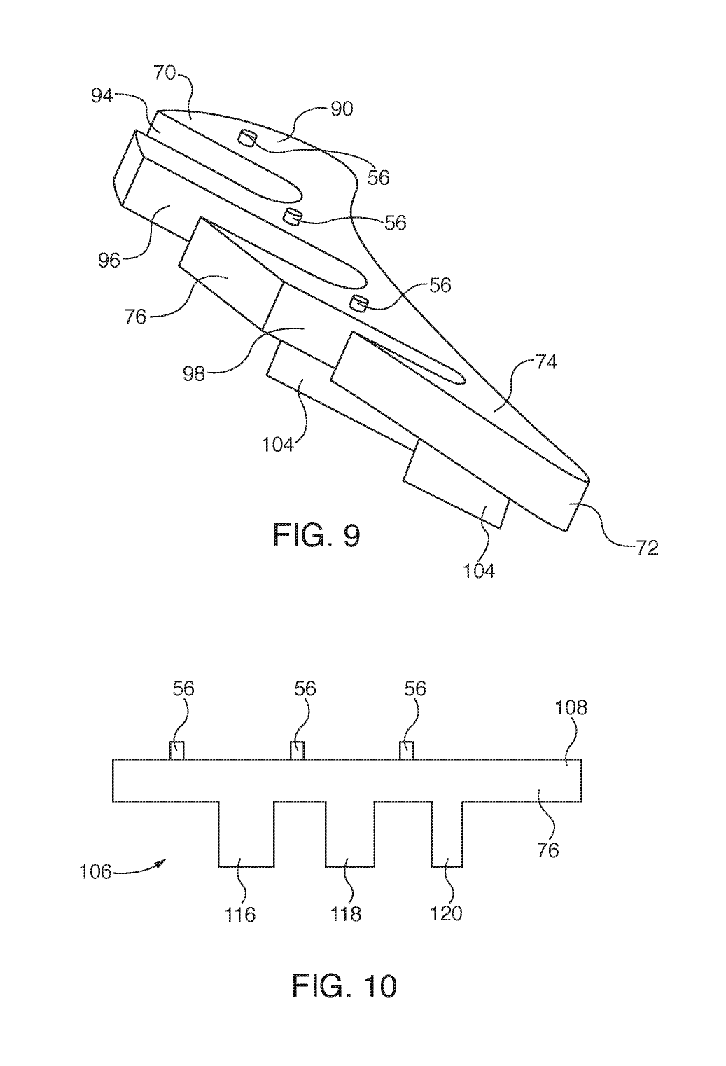

FIGS. 7-8 show top and bottom views, respectively, of a first vane filament 90. The first filament 90 includes the leading 70 and trailing 72 edges and the concave 74 and convex 76 side surfaces as previously described. The first filament 90 also includes a plurality of side apertures 92 that extend into the first filament 90 from the convex side surface 76 of the first filament 90. In an embodiment, the first filament 90 includes first 94, second 96 and third 98 side apertures for receiving the first 42, second 44 and third 46 support beams, respectively. The first filament 90 also includes a top surface 100 having the alignment pins 56 (see FIG. 7) and a bottom surface 102 having the alignment holes 64 (see FIG. 8). Alternatively, the pins 56 and alignment holes 64 may be formed on bottom 102 and top 100 surfaces, respectively, of the first filament 90. Referring to FIG. 9, a perspective view of the first filament 90 along view line 9-9 of FIG. 7 is shown. The first filament 90 further includes a plurality of flange elements 104 that extend downward from the concave side surface 74. The location and number of flanges 104 correspond to the apertures of an underlying filament and serve to close openings due to the apertures. In an embodiment, the first filament 90 includes first 110, second 112 and third 114 flanges (see FIG. 12) that correspond to the first 80, second 82 and third 84 side apertures of the base filament 68 (see FIG. 5) or the second filament 108 as will be described.

Referring to FIG. 10, a view of the first filament 90 along view line 10-10 of FIG. 5 is shown. In an alternate embodiment, the base filament 68 includes a plurality of flange elements 106 that extend downward from the convex side surface 76 to form a second filament 108. The location and number of flanges 106 correspond to the apertures of an underlying filament and serve to close openings due to the apertures. In an embodiment, the second filament 108 includes first 116, second 118 and third 120 flanges that correspond to the first 94, second 96 and third 98 side apertures, respectively, of the first filament 90 (see FIG. 9).

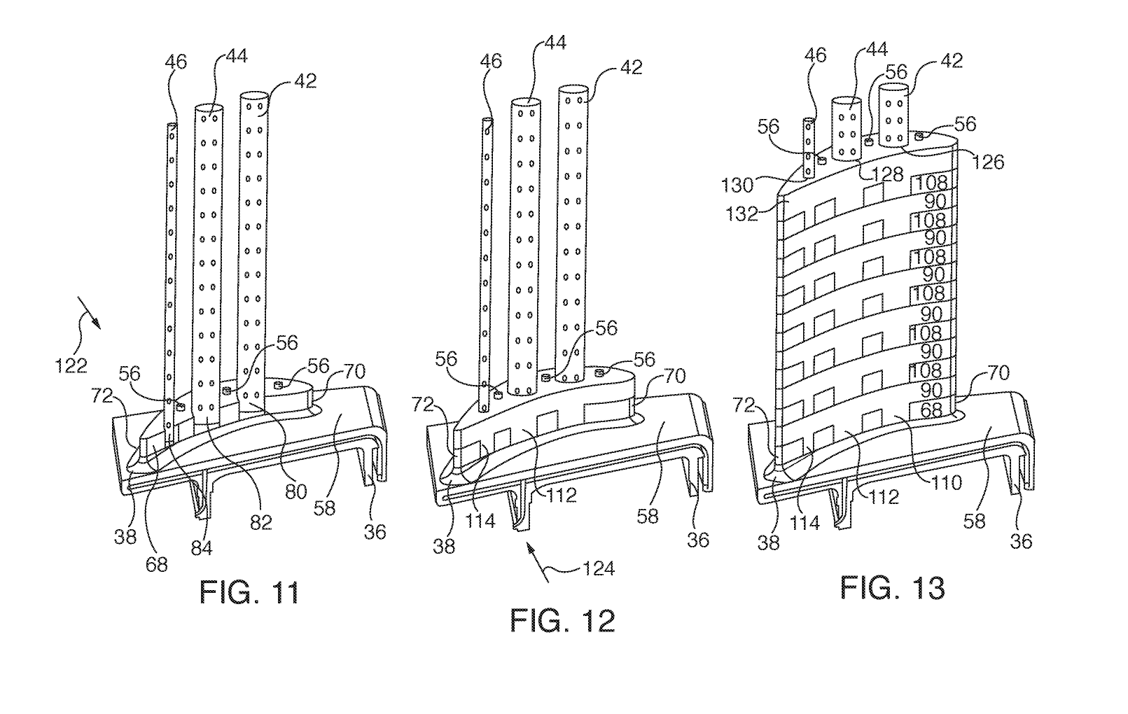

Referring to FIGS. 11-13, a filament assembly sequence for forming the vane 30 is shown. In accordance with embodiments of the invention, each filament 68, 90, 108 is inserted in a direction transverse to the orientation of the support beams to facilitate the formation or assembly of a vane having a complex three dimensional (3D) shape or curvature. In an embodiment, the filaments 68, 90, 108 are slid onto the support beams sequentially in alternating transverse directions. Referring to FIG. 11, the base filament 68 is moved or slid in a first transverse direction 122 (see arrow) until the base filament 68 is located above the lower platform 38 and the support beams 42, 44, 46 are located within the apertures 80, 82, 84, respectively, of the base filament 68. The base filament 68 is then lowered onto the lower platform 38 such that the alignment pins 56 of the lower platform 38 are received by the alignment holes 64 of the base filament 68.

Referring to FIG. 12, a first filament 90 is then moved in a second transverse direction 124 (see arrow) that is substantially opposite the first direction. The first filament 90 is moved until the first filament 90 is located above the base filament 68 and the support beams 42, 44, 46 are located within apertures 94, 96, 98 of the first filament 90. The first filament 90 is then lowered or stacked onto the base filament 68 such that the pins 56 of the base filament 68 are received by the alignment holes 64 of the first filament 90. Upon lowering of the first filament 90 onto the base filament 68, the flanges 110, 112, 114 of the first filament 90 cover the apertures 80, 82, 84, respectively, of the base filament 68 thereby closing the apertures 80, 82, 84.

A second vane filament 108 is then moved or slid in the first transverse direction 122 as previously described in connection with the base filament 68. The second filament 108 is then lowered onto the first filament 90 such that the pins 56 of the first filament 90 are received by the alignment holes 64 of the second filament 108. Upon lowering of the second filament 108 onto the first filament 90, the flanges 116, 118, 120 of the second filament 108 (FIG. 10) cover the apertures 94, 96, 98, respectively, of the first filament 90 (FIG. 9) thereby closing the apertures 94, 96, 98. The first 90 and second 108 filaments form a filament pair. Additional first 90 and second 108 filament pairs are then stacked as previously described such that flanges 110, 112, 114 of a first filament 90 cover apertures 80, 82, 84 of an underlying second filament 108 and flanges 116, 118, 120 of a second filament 108 cover apertures 94, 96, 98 of an underlying first filament 90 to form an interlocked arrangement. In an embodiment, additive manufacturing and 3D printing techniques may be used to generate an interlocked filament arrangement as described herein.

As previously described, the filaments 32 are inserted in a direction transverse to the orientation of the support beams 42, 44, 46 to facilitate the assembly of a vane having a complex 3D shape or curvature. Once a substantial portion of the vane 30 that includes the 3D shape or curvature is assembled, at least one filament that includes through holes rather than side apertures may be used. For example, the side apertures 94, 96, 98 of the first filament 90 (FIG. 9) are replaced by corresponding round holes 126, 128, 130 (FIG. 13) that are configured to receive the first 42, second 44 and third 46 support beams, respectively to form a third vane filament 132. The third filament 132 is installed in a radial direction over the first 42, second 44 and third 46 support beams and may be the last filament installed in the vane 30.

The lower backing plate 36, support beams 42, 44, 46 and filaments 68, 90, 108, 132 are then heated by a sufficient amount of heat to cause a desired lengthening of the beams 42, 44, 46. Referring back to FIG. 2, the upper backing plate 34 is then inserted over the first 42, second 44 and third 46 support beams such that the support beams 42, 44, 46 extend through the holes 62 (see FIG. 4) and the ends 48 are located above the upper backing plate 34. In addition, the alignment holes 64 receive the alignment pins 56 of the third filament 132. The ends 48 are then welded to the upper backing plate 34 using a known welding technique such as friction welding to form the vane 30. The vane 30 is then cooled down to room temperature, which contracts the support beams 42, 44, 46. As a result, the vane 30 is held under compression when at room temperature. The filaments 68, 90, 108, 132 may then be machined in order to achieve a desired vane profile or shape.

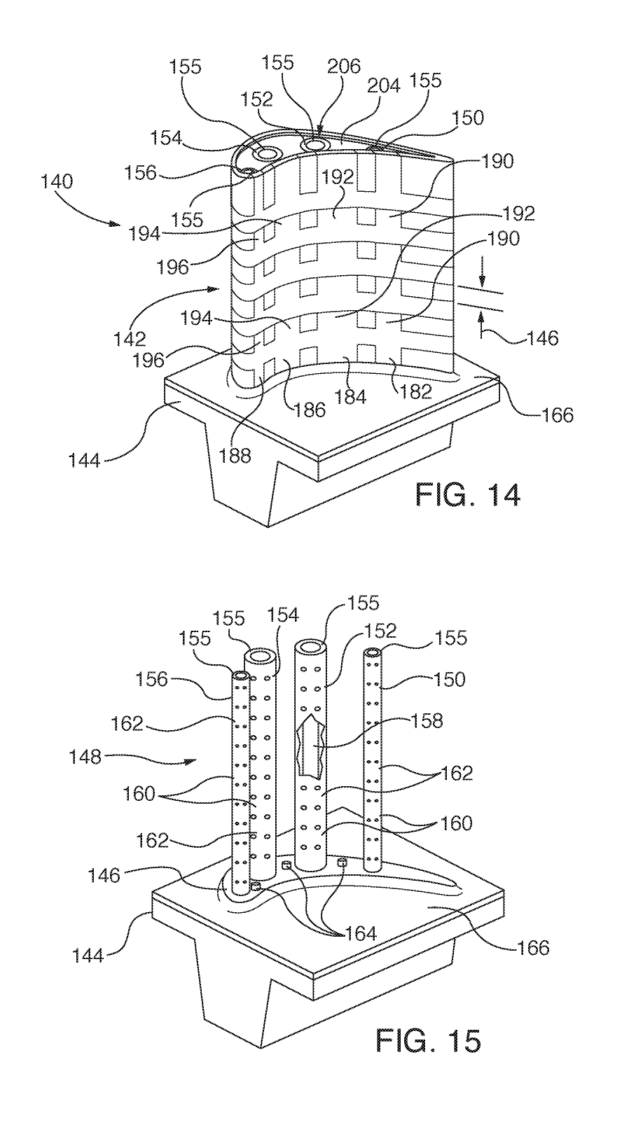

The current invention is also applicable to fabricating a blade of a multi stage turbine section of the turbine 10. Referring to FIG. 14, a modular blade 140 in accordance with an alternate embodiment of the invention is shown. The blade 140 includes a plurality of blade filaments 142 arranged in a stacked configuration on a blade hub 144 that is ultimately attached to the shaft 24. The filaments 142 are each fabricated from a relatively light weight and high heat resistant material such as CMC or TiAl material as previously described. Alternatively, at least one filament 142 may be fabricated from one type of a high heat resistant material, such as CMC material, whereas the remaining filaments 142 may be fabricated from another type of high heat resistant material, such as TiAl material. The filaments 142 are each shaped such that a suitable blade airfoil shape is formed when the filaments 142 are stacked or assembled. The filaments 142 may each have a first thickness 146. In an embodiment, the thickness 146 of a filament 142 fabricated from CMC material may be approximately 10-12 mm thick. Alternatively, at least one filament 142 may have a thickness that is greater or less than the first thickness 146.

Referring to FIG. 15, the blade hub 144 is shown without the filaments 142 installed. The blade hub 144 includes a platform 146 having a plurality of support beams 148 that extend from the platform 146 in a radial direction relative to the center axis 20. In an embodiment, the blade hub 144 includes first 150, second 152, third 154 and fourth 156 support beams each having a threaded end 155. Each support beam 150, 152, 154, 156 includes an internal channel 158 (shown as a cutaway view in second support beam 152) and a plurality of apertures 160 that extend through an outer surface 162 of each support beam 150, 152, 154, 156 such that each internal channel 158 and associated apertures 160 are in fluid communication. In use, each internal channel 158 receives cooling air that is then emitted from the apertures 160 and impinges on the filaments 142 in order to cool the filaments 142. A plurality of alignment pins 164 also extend from platform 146. The support beams 150, 152, 154, 156 and pins 164 serve to support and align the filaments 142 as will be described.

The blade hub 144, support beams 150, 152, 154, 156 and pins 164 may be integrally or unistructurally formed, such as by a casting process, to form a one-piece configuration. In an embodiment, blade hub 144, support beams 150, 152, 154, 156 and pins 164 may be formed from a known Conventional Cast (CC) alloy or Directionally Solidified (DS) alloy. A hub shroud element 166 covers portions of the blade hub 144. The hub shroud 166 is fabricated from a heat resistant material that serves to reduce exposure of the blade hub 144 to high temperatures such as CMC material or a known thermal barrier coating.

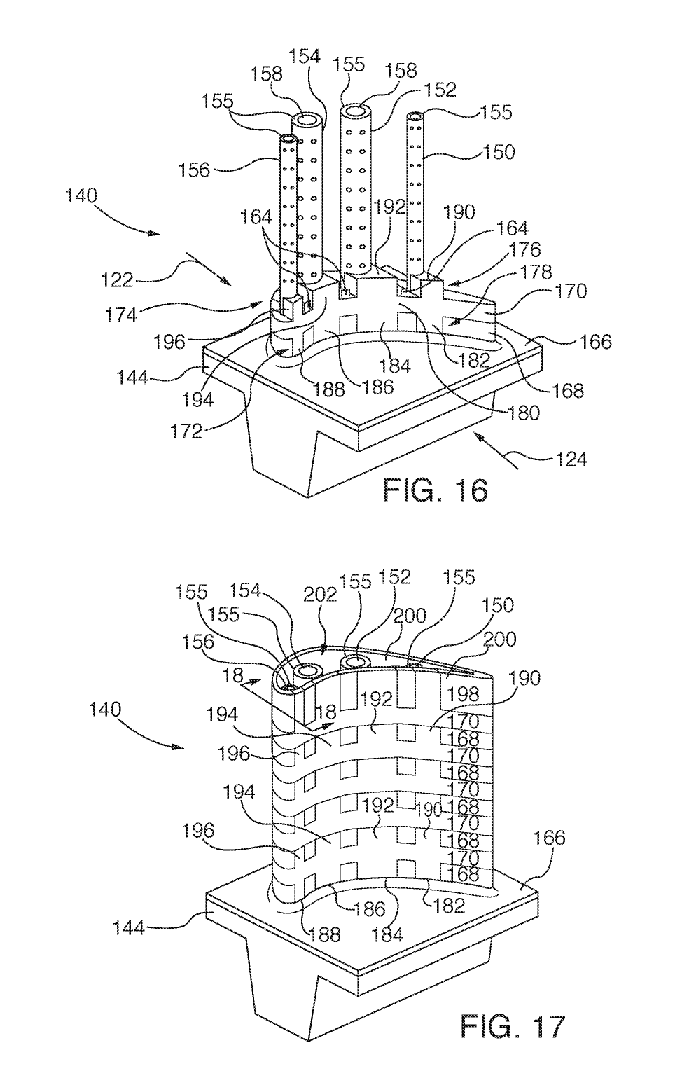

The filaments 142 for the blade 140 are inserted in a direction transverse to the orientation of the support beams 150, 152, 154, 156 as previously described in relation to FIGS. 11-13 to facilitate the assembly of a blade having a complex 3D shape or curvature. Referring to FIG. 16, a partially assembled blade 140 is shown. The blade 140 includes a blade filament 168 having filament apertures 172 (shown covered) and a flanged blade filament 170 having filament apertures 174. The blade filament 168 is slid in the first transverse direction 122 (see arrow) such that the filament apertures 172 receive the support beams 150, 152, 154, 156. Subsequently, the flanged filament 170 is slid in the second transverse direction 124 (see arrow) such that the filament apertures 174 also receive the support beams 150, 152, 154, 156.

In an alternate embodiment, the flanged filament 170 includes first 176 and second 178 flange elements that extend upward and downward, respectively, from a concave surface 180 of the flanged filament 170. In FIG. 16, first 182, second 184, third 186 and fourth 188 downward flanges are shown which cover corresponding apertures 172 in the base filament 168. FIG. 16 also depicts first 190, second 192, third 194 and fourth 196 upward flanges which are configured to cover apertures in a filament placed on top of the flanged filament 170. Alternatively, the flanged filament 170 may only include the first 182, second 184, third 186 and fourth 188 downward flanges or the first 190, second 192, third 194 and fourth 196 upward flanges.

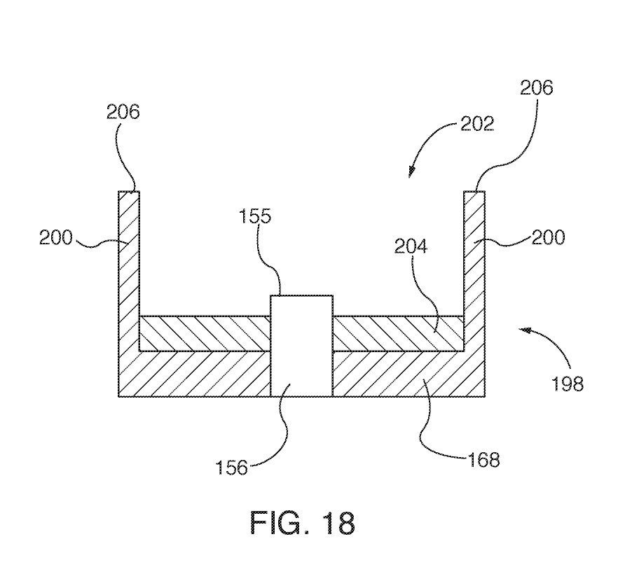

Referring to FIG. 17, a plurality of filaments 168, 170 are slid onto the support beams 150, 152, 154, 156 sequentially in alternating transverse directions until a desired configuration is achieved. An end filament 198 is positioned above a last flanged filament 170. Referring to FIG. 18, a partial cross sectional view of the end filament along view line 18-18 of FIG. 17 is shown. Referring to FIG. 18 in conjunction with FIG. 17, the end filament 198 includes the base filament 168 and side walls 200 that extend above the base filament 168 which form a cavity 202 having a shape that corresponds to that of the base filament 168. The blade 140 further includes a compression plate 204 having a shape corresponding to the cavity 202 (see FIG. 14). The blade 140 includes holes 206 for receiving the support beams 150, 152, 154, 156.

The blade hub 144, support beams 150, 152, 154, 156 and filaments 168, 170, 198 are then heated by a sufficient amount of heat to cause a desired lengthening of the beams 150, 152, 154, 156. The compression plate 204 is then inserted over the support beams 150, 152, 154, 156 such that the support beams 150, 152, 154, 156 extend through the holes 206 and the ends 155 are located above the compression plate 204 and below an upper edge 206 of the side walls 200. The ends 155 are then welded to the compression plate 204 using a known welding technique such as friction welding to form the blade 140. The blade 140 is then cooled down to room temperature, which contracts the support beams 150, 152, 154, 156. As a result, the blade 140 is under compression when at room temperature. The filaments 68, 90, 108, 132 may then be machined in order to achieve a desired blade profile or shape.

While particular embodiments of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. An airfoil for a turbine, comprising:
at least one support column extending from a backing plate;
at least one first filament having at least one first side aperture that receives the support column in a first transverse direction; and
at least one second filament having at least one second side aperture that receives the support column in a second transverse direction, wherein the second filament includes a flange for covering the first side aperture.

2. The airfoil according to claim 1, wherein the first and second filaments have a vane or blade shape.

3. The airfoil according to claim 1, wherein the second filament includes at least one upward and one downward extending flange.

4. The airfoil according to claim 1, wherein the first and second elements are fabricated from a high heat resistant material.

5. The airfoil according to claim 4, wherein the high heat resistant material is either ceramic matrix composite material or Titanium Aluminide material.

6. The airfoil according to claim 1, wherein the flange extends from a side surface of the second filament.

7. The airfoil according to claim 1, further including a shroud that covers the backing plate.

8. An airfoil for a turbine, comprising:
at least one support column extending from a lower plate;
at least one first filament having at least one first side aperture that receives the support column in a first transverse direction; and
at least one second filament having at least one second side aperture that receives the support column in a second transverse direction opposite the first direction, wherein the second filament includes a flange for covering the first side aperture;
a cooling channel extending through the support column, wherein the support column includes apertures for emitting a cooling fluid transmitted via the cooling channel for cooling the first and second filaments; and
an upper plate located on top of the first and second filaments for maintaining the first and second filaments under compression.

9. The airfoil according to claim 8, wherein the first and second filaments have a vane or blade shape.

10. The airfoil according to claim 8, wherein the second filament includes at least one upward and one downward extending flange.

11. The airfoil according to claim 8, wherein the first and second elements are fabricated from a high heat resistant material.

12. The airfoil according to claim 11, wherein the high heat resistant material is either ceramic matrix composite material or Titanium Aluminide material.

13. The airfoil according to claim 8, wherein the flange extends from a side surface of the second filament.

14. The airfoil according to claim 8, wherein the upper and lower plates each include a shroud.

15. A method for assembling an airfoil for a turbine, comprising:
providing at least one support column extending from a lower plate;
providing at least one first filament having at least one first side aperture that receives the support column in a first transverse direction;
providing at least one second filament having at least one second side aperture that receives the support column in a second transverse direction opposite the first direction, wherein the second filament includes a flange for covering the first side aperture;
heating the support column to lengthen the support column;
attaching an upper plate to the support column; and
cooling the support column to contract the support column and place the first and second elements under compression.

16. The method according to claim 15, wherein the first and second filaments have a vane or blade shape.

17. The method according to claim 15, wherein the second filament includes at least one upward and one downward extending flange.

18. The method according to claim 15, wherein the first and second elements are fabricated from a high heat resistant material.

19. The method according to claim 18, wherein the high heat resistant material is either ceramic matrix composite material or Titanium Aluminide material.

20. The method according to claim 15, wherein the flange extends from a side surface of the second filament.
